(19) United States
(12) Patent Application Publication
(10) Pub. No.: US 2020/0265701 A1
(43) Pub. Date: Aug. 20, 2020

(54) SYSTEMS AND METHODS FOR DETECTING AND MONITORING HAZARDOUS OBSTACLES

(71) Applicants: Eran SCHENKER, Tel Aviv (IL); Ronny Schenker, Jerusalem (IL)

(72) Inventors: Eran SCHENKER, Tel Aviv (IL); Ronny Schenker, Jerusalem (IL)

(21) Appl. No.: 16/862,229

(22) Filed: Apr. 29, 2020

Related U.S. Application Data
(63) Continuation-in-part of application No. PCT/IL2018/051160, filed on Oct. 31, 2018.
(60) Provisional application No. 62/579,160, filed on Oct. 31, 2017.

(51) Int. Cl. G08B 21/04; G01C 21/36; G01C 21/34; G01S 19/01; G06K 9/00

(52) U.S. Cl. CPC G08B 21/0461; G01C 21/36; G01C 21/3415; A61H 3/066; G06K 9/00671; G06K 9/0063; G08B 21/0476; G01S 19/01

(57) ABSTRACT

A health hazards geolocation control system for monitoring potential health hazards (PHHs) endangering users using the system for detecting PHHs endangering them, for example a pedestrian, wherein the system may include a personal health hazards monitoring system having an image capturing and processing units, and wherein the image sensor is situated in the vicinity of the user, for example, by wearing it or is flown by a drone associated with that system. Upon detecting a PHH the system warns the user to prevent their fall. The geolocation control system, or similar systems of, may be by the user or other users, to form a pool of health hazards and associated score. Thus, other users on that location may be warned of the reported health hazard. The system may advise a user which is the safest path to walk, having a minimal, level or number of PHHs, and highest safety score.

### CROSS REFERENCE TO RELATED APPLICATIONS

This application is a continuation-in-part of International Patent Application No. PCT/IL2018/051160 filed on Oct. 31, 2018, which claims the benefit of priority to U.S. Provisional Application No. 62/579,160 filed on Oct. 31, 2017, the contents of which are incorporated by reference in their entirety.

### FIELD

The present disclosure relates to health hazards control systems and particularly, to geolocation health hazards control system for monitoring and maintaining a geolocation database of potential health hazards endangering users using the system, and for detecting potential health hazards (PHHs) endangering a user, for example a pedestrian, wherein the system may include at least one imaging monitoring sub system having an image capturing and processing units, and wherein the image sensor is situated in the vicinity of a user, for example, by wearing it or is flown by a drone associated with that user.

### BACKGROUND

Falls are common throughout adulthood. Each year in the U.S., approximately 19,000 people die from unintentional falls, 500,000 are hospitalized, and 8 million are treated in Emergency Departments. Injuries from falls are especially common among the elderly; falls are the leading cause of fatal and nonfatal injuries among people aged ≥65 years. Direct medical costs for fall-related injuries in people aged ≥65 years exceeded $19 billion (Mertz 2010, doi: 10.1016/j.amepre.2010.03.013).

Physical activity has many health benefits but may increase falls risk. Associations between physical activity and falls differed by presence of mobility limitations. In an intervention study among 66% of men without mobility limitations the number of falls increased incrementally for every 30 min of moderate to vigorous physical activity (Jefferis 2015, doi: 10.1249/MSS.0000000000000635). Falls and in particular fear of falling are important barriers to older people gaining health benefits of walking (Jefferis 2014, doi: 10.1186/1471-2318-14-114). Falls were the most frequently reported accidents in all age brackets in study on 0-12, 12-24, and 24-48-months of age, followed by cuts and burns (Barcelos 2017, doi: 10.1590/0102-311X00139115). In a study on childhood accidents in primary health care the finding were the same. One of the most frequent causes were falls (30.5%) in a study population of 2,543 children 0-14 years old (Galdón 1995, https://www.nbci.nlm.nih.gov/pubmed/7644887). kids with ADHD were nearly twice as likely to suffer an injury that sent them to the hospital at some point in their lives compared to kids without ADHD. Fractures were 10.4 percent of the injuries (Rettner 2011, https://www.livescience.com/35944-adhd-injuries-kids.html). Recent systematic review and meta-analysis on Attention deficit/hyperactivity disorder and risk of injuries, have confirmed the results and statement in other group-ages as well. Those with ADHD are nearly two times more likely to be injured. Children, adolescents and adults with ADHD are all at higher risks of various types of mostly unintentional injuries (Amiri 2017, 10.5249/jivr.v9i2.858).

The relationship between higher-level cognitive function and gait disturbances have received considerable attention in recent years. Gait is no longer considered as merely an automated motor activity that utilizes minimal higher-level cognitive input. Instead, the multifaceted neuropsychological influences on walking and the interactions between the control of mobility and related behaviors are increasingly appreciated. This is manifest in part by an individual's awareness of a destination, the ability to appropriately control the limb movements that produce gait, and the ability to navigate within often complex environs to successfully reach the desired location. The role of executive function and attention in gait (Yogev 2008, doi:10.1002/mds.21720).

The number of falls injuries associated with cellular phone use during walking has been increasing. Although walking is thought to be a more automatic motor task compared to driving, cell phone use may cause cognitive distraction, reduced visual attention to the environment, and altered physical demands such as reduced arm swinging and altered head orientation (Schabrun 2014, doi:10.1371/journal.pone.0084312). Distraction from cell phone use was shown to affect pedestrian behavior, for example, reducing situation awareness and increasing unsafe pedestrian behavior while crossing the street. walking stability might be compromised during cell phone use, which would lead to an increased risk of falls (Kao 2015, doi:10.1016/j.gaitpost.2015.03.347).

The nature of many occupations' activities includes unsafe environment and fall risk due to not paying attention while focusing on their primary mission. Few examples like first responders, emergency medical service (EMS), fire fighters, special military teams. In the short list of the main hazards in EMS and fire fighters causes of injuries, falls are the primary factor in 18% of the cases (Yoon et al., 2016 DOI: 10.3346/jkms.2016.31.10.1546).

About thirty percent of community-dwelling elderly adults 65 years old fall each year, which is often caused by a combination of medical, social and environmental factors (Khow 2017, http://www.geriatric.theclinics.com/article/S0749-0690(17)30016-2/fulltext).

Falls are a leading cause of injury among elderly adults. Approximately 25 percent of persons who fall have moderate to severe injuries, ranging from bruises or lacerations to hip fractures or traumatic brain injury (Yoshida 2007, http://www.who.int/ageing/projecrts/1.Epidemiology_falls_olderage.pdf).

Elderly adults value their independence and a fall can significantly reduce their ability to remain self-sufficient. Falls are responsible for significant disability, limitations in activity, hospitalization, loss of independence, and reduced quality of life and institutionalization.

Falls are the leading cause of death from injury in persons elderly than 65 years, and mortality from falls has increased by 42 percent over the past decade. Every second of every day in the US, an elderly adult fall, and every 20 minutes an elderly adult dies from a fall. In 2014, there were 29 million falls, 7 million requiring medical treatment. This makes falls far more common than many health conditions that affect elderly adults (Lee 2017, http://www.aafp.org/afp/2017/0815/p220.html).

Falls also carry a substantial economic burden. The average fall-related hospitalization costs $30,000, and falls rank fifth in terms of highest personal health care spending. The Centers for Disease Control and Prevention (CDC) estimates that Medicare spends roughly $31 billion on falls annually. These statistics will only worsen as America's baby boomer population (born between 1946 and 1964) turns 65 years of age. By 2030, one in five Americans will be at least 65 years of age, and without preventive efforts, the CDC estimates there may be 49 million falls and 12 million fall-related injuries annually. In the future new architecture and infrastructures concepts may pose new threats to pedestrians, increasing their risk of falls.

The exponential spread rate of the coronavirus pandemic has pushed a number of countries to use geolocation data to help battle this unsettling outbreak. In many cases, the data has been a boon for authorities looking to track movements across provinces and regions and the overall effectiveness of measures like sheltering in place. In this description a user can be alerted from other users, which update the system that he/she is possible infect. It should be appreciated that an infected person may be viewed as a mobile PHH. Some publications related to the coronavirus pandemic are listed herein:
https://searchengine1and.com/what-location-data-can-tell-us-about-the-covid-19-pandemic-332146https://www.israeldefense.co.il/en/node/42412;
https://cis.verint.com/resoucrs/gelocation-for-covid-19-crisis-management/;
https://www.cnet.com/news/europes-privacy-officials-are-working-on-geolocation-guidelines-for-tracking-covid-19/; and
https://edpb.europa.eu/our-work-tools/our-documents/other/mandate-geolocation-and-other-tracing-tools-context-covid-19_en.

Governments, local and international agencies and have all using new measures to help contain the spread of the COVID-19, otherwise know as the Coronavirus. Some of these measures impose severe restrictions on people's freedoms, including to their privacy and other human rights. Unprecedented levels of surveillance, data exploitation, and misinformation are being tested across the world. Some may be effective and based on advice from epidemiologists needs. Geolocation become part of fighting endemic now days. American federal, state and local governments are said to have started collecting and scrutinizing data from the mobile advertising industry in an effort to enforce social distancing. The reported steps come as the country struggles to contain the spread of COVID-19. The data is said to be collected from the advertising industry, which receives geolocation data when people sign up for apps. (IsraelDefense, 31 Mar. 2020. https://www.israeldefense.co.il/en/node/42412).

There is therefore a need and it would be advantageous to have a technological solution that identify, alert and prevent falling from physical related hazards in the everyday environments, where elderly people live and engage.

### SUMMARY

The principle intentions of the present disclosure include providing a geolocation health hazards control system, having at least one personal health hazards monitoring sub-system, for substantially decreasing the number of encountered health hazards by moving users, such as young children, the elderly, and other distractions for users being in a path of motion, such as while walking, running, skiing, and other physical activities.

It should be noted that a user of a personal health hazards monitoring system is typically a pedestrian, and therefore is often described as the user being a pedestrian. However, the present disclosure is not limited to pedestrians and any other moving users may use the system of the present disclosure, including users on wheelchairs, users riding horses or other animals, animals such as, with no limitations, guide dogs and moving controlled objects out door or indoor.

A personal health hazards monitoring system may include at least one image sensor for continuously capturing images in the vicinity of a user, for example, by wearing the image sensor or is flown by a drone associated with that user. The personal health hazards monitoring system further includes a memory unit for storing the captured images and a processing unit for processing the captured images.

Typically, the image sensor is adapted to be worn by the user subject, typically a pedestrian user, for example mounted on a hip belt, or to be carried by a selfie drone associated with the user subject, such that images acquired by the image sensor represent the surroundings of a user subject, the user subject being in motion. The processing unit is configured to process images captured by the image sensor and stored in the memory unit. The processing unit is configured to detect, mark or remotely received including time and place of one or more potentially health hazards (PHHs) in the pathway of the user, during movement of the user, which health hazards may cause a stumble or a fall of the user or the user may be hurt from exposed infected matter, including droplets and or airborne hazards like a bacteria, virus or fungal. One of the PHHs may have a feature that the image processor may detect, such as high temperature detection to diagnose steady fever in airports, while people are on the move. In this case the camera is mobile and serve one to all. Other diseases may be detected like skin contact, respiratory or infection vector. The camera can detect for example droplet sneezing cloud and pathway, which may be infected. Moreover, the optical method may detect high density of fluorescent antibody tagged colored for bacteria, fungal or virus like Coronavirus for COVID-19 diagnosis. Such a PHH may be set in two steps: one discharging the markers nearby, and the second step declare the PHHs.

Upon detecting a health hazard such as a hazardous obstacle, the processing unit is configured to alert the user. Preferably, the processing unit is further configured to provide the user subject with instruction as to how to conduct his movements in order avoid encountering the detected PHH.

It should be appreciated that a PHH may take a myriad of shapes and forms, some of which are listed in the following list:
a. fixed obstructions on pavements and pedestrian user movement like a walking paths including curbs, cracks, fissures, uneven grates, manholes, pits, slopes, uneven paving, sidewalk gutters that are insufficiently marked or too narrow, light rail or streetcar tracks, drainage grates and outdoor stairs;
b. temporary obstructions on pavements and user movement like a walking paths—piles of uncollected trash, fruits/vegetable peeling, fallen leaves, pools of water after heavy rain and low hanging branches or other overhanging decorative items (e.g., flags, posters);
c. pavement construction materials including bricks surface such as cobble stone surface, tactile pavement for the visually impaired;
d. multiple sources of traffic/busy intersections;
e. vehicles, including cars, motorcycles, bicycles fully or partially parked on walkways, cyclists, skateboarders, other electric transporter and other devices used by pedestrian, predefined excessive pedestrian crowding and small children;
f. animals and other none-human subjects;
g. persons or animals carrying none-human subjects selected from a group including bacteria, fungal, virus and astrobiology mater;
h. weather conditions (rain, snow, ice);
i. light conditions, including daylight, dim light, poor lighting, darkness;
recreational areas; and
k. input from a mobile device that distracts the user from paying attention to the pathway.

Optionally, the processing unit of the health hazards monitoring system is further configured to locate, map, update and declare hot spots of health hazards through a Geolocation/Geographic Information System (GIS) designed to locate, analyze and present spatial geographic health hazards data in the indoor or outdoor environments, private, public, country side or urban locations, the data kept in a database with real-time time-stamp. Such a database of mapped health hazards enables to advise the best pathway for a walk/run with minimal potential for health hazards events, for example, by providing a safety score for the selected pathway. Such a database of mapped health hazards data in the geographic public space may also be used by government authorities for mending and removing such health hazards. In some embodiments, the geolocation health hazards data in the urban public space is built manually.

The geolocation health hazards may be used as part of geolocation data assist in monitoring infection control like the COVID-19 pandemic and others in the future. Rather than getting from government agency a message that a user was near by other users, the PHH system enables a positive user with obstacle non-human that may hurt other users, to mark himself as an obstacle. Then while the infected subject moves in the public area, other users may get alerts when a predefine distance from the other users is bridged. This geolocation is not used retrospective to send a message to users that crossed an infective person after one have been diagnosed but used for future potential cross over the infected user. This may be used to eliminate ordering a big population to be isolated as the source of a user acting as a safety hazard is usually not known.

The processing unit of the personal health hazards monitoring system can calculate, for the user, the safest pathway leading from location A to location B without the worry of crossing known health hazards or with known infection user. At the same time, when approaching a zone with known health hazards, the system can alert the user to increase his/her awareness. By generating a virtual GIS health hazards map, the system knows to alert and avoid obstacles, for example, by imbedding the concept of Foreign Object Debris (FOD) technology. The system may also capture Almost Falls Events (AFE) that may be utilized as well. Geolocation real-time feature may eliminate fall into a disease. High PHH of many users with a predefine mark generate red PHH zones that on a GIS map important to public health officers and bio informatics analysis.

Optionally, the processing unit of the health hazards monitoring system is further configured to personalize the processing algorithm, interchangeably referred to as the “health-hazard-detection-and-monitoring algorithm”. For example, when detecting a in the user pathway, the health-hazard-detection-and-monitoring algorithm analyzes the distance of the health-hazard-detection-and-monitoring algorithm from the user and calculates the number of steps that will take the user to reach the health hazard. To calculate that the algorithm obtains or determines the unique gait (e.g. step length) of that specific user. The user's gait can be calculated per user with an accelerometer sensor and/or the image sensor or any other method known in the art. The health-hazard-detection-and-monitoring algorithm may also interface with the personal mobile device of that user or other users. In another example, the health-hazard-detection-and-monitoring algorithm may obtain information of any cognitive or movement disorders that the user presents or suffers from that may result in a fall, for example, a Parkinson's Disease. Other movements related diseases may include the following medical disorders: Ataxia Telangiectasia, Cerebellar Disorders, Cerebral Vascular Accidents (CVA), Multiple Sclerosis, Developmental coordination disorder (DCD), Dyspraxia. Dystonia, Muscle Disorders, Neuromuscular Disorders, Progressive Supranuclear Palsy, Tourette Syndrome, Angelman, Chorea, Sydenham Chorea, Fragile X-Associated Tremor and Ataxia Syndrome, Functional Movement Disorder, Myoclonus, Neuroacanthocytosis, Neurodegeneration with Brain Iron, Paroxysmal Choreoathetosis, Paroxysmal Dyskinesias, Huntington's chorea and Tardive Dyskinesia. Neurodevelopmental disabilities such as Cerebral Palsy.

In the same manner the cognitive disorder list includes: Alzheimer's disease and other types of Dementia, Amnesia, Attention Disorders. Attention deficit hyperactivity disorder (ADHD), Binswanger's disease, Clouding of consciousness, Developmental Cognitive disability, Cognitive deficit, cognitive dysfunction, cognitive impairment, Cognitive slippage, Cognitive vulnerability, conscious awareness, Delirium, Dementia, Dissociative disorders, Disabilities affecting intellectual abilities, Genetic disorders such as Down Syndrome walking awareness.

For example, dizziness and balance problems in children has an overall prevalence of 5.3% in 3-17 year old children and increasing prevalence with age. Children with seizure disorders often have dizziness and balance problems. Hearing difficulty is associated with dizziness and balance problems in children (Li et al., 2016 https://www.nbci.nlm.nih.gov/pubmed/26826885).

The health-hazard-detection-and-monitoring algorithm may also detect cognition awareness problems for normative users who do not pay attention to the pavement while moving thereon, for example when focusing in other tasks such as attending mobile phone related tasks.

Optionally, if the health-hazard-detection-and-monitoring algorithm determines, when a known or detected health hazard in the user pathway, the health-hazard-detection-and-monitoring algorithm analyzes if that specific user will pass that health hazard safely, the health-hazard-detection-and-monitoring algorithm will not alert the user. Even if the health hazard may be between two following steps the health-hazard-detection-and-monitoring algorithm can calculate based on the personal gait and walking predefined and updated in real-time that the user will pass and not step on the health hazard and will eliminate the need to activate the alert mode. In the same health hazard that a specific user is handling well with low risk to fall may not as well generate an alert to minimize the falls alarms of the system.

Unless otherwise defined, all technical and scientific terms used herein have the same meaning as commonly understood by one of ordinary skill in the art to which this disclosure belongs. The materials, methods, and examples provided herein are illustrative only and not intended to be limiting. The present disclosure can be implemented in the testing or practice with methods and materials equivalent or similar to those described herein.

As used herein, a phrase referring to “at least one of a list of items refers to any combination of those items, including single members. As an example, at least one of: a, b, or c” is intended to cover: a, b, c, a-b, a-c, b-c, and a-b-c.

Implementation of the example methods and systems of the present disclosure can involve performing or completing certain selected tasks or steps manually, automatically, or a combination thereof. Moreover, according to actual instrumentation and equipment of the example methods and systems of the present disclosure, several selected steps could be implemented by hardware and/or by software. Actual instrumentation is not hardware or firmware specific and can be realized by using operating systems, firmware, and combinations thereof as would be appreciated and understood by a person of ordinary skill in the art according to the principles of the present disclosure. For example, as hardware, selected steps of the present disclosure can be implemented as a chip, a circuit, a distributed computing system, or a network of such systems and devices. As software, selected steps of the present disclosure could be implemented as a plurality of software instructions being executed by a computing system, computing device, and/or network thereof using any suitable operating system. In any case, selected steps of the example methods and systems of the present disclosure can be described as being performed by a data processor, such as a computing platform for executing a plurality of instructions.

Although the present disclosure is described with regard to a “computing device”, a “computer”, or “mobile device”, it should be noted that optionally any device featuring a data processor and the ability to execute at least one instruction may be described as a computer, including but not limited to a personal computer (PC), a server, a distributed server, a digital server, a cloud computing platform, a collection of servers, load balanced microservices, or redundant architecture servers, a cellular telephone, or a PDA (personal digital assistant), and the like. Any two or more of such devices in communication with each other may optionally define a “network” or a “computer network”.

The various illustrative logics, logical blocks, module executing on data processors (“processors”), circuits and algorithm steps described in connection with the implementations disclosed herein can be implemented as electronic hardware, computer software, or combinations of both. The interchangeability of hardware and software has been described generally, in terms of functionality, and illustrated in the various illustrative components, blocks, module executing on a processors, circuits and steps described above. Whether such functionality is implemented in hardware or software depends upon the particular application and design constraints imposed on the overall system.

The hardware and data processing apparatus used to implement the various illustrative logics, logical blocks, module executing on a processors and circuits described in connection with the aspects disclosed herein can be implemented or performed with a single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, or, any processor, controller, microcontroller, or state machine. A processor also may be implemented as a combination of electronic devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more module executing on a processors of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module executing on a processor which may reside on a computer-readable medium. Computer-readable media can include computer storage media and/or communication media including any medium that can be enabled to transfer a computer program from one place to another. Storage media can be media that can be accessed by a computer. Storage media can include volatile and non-volatile, removable and non-removable tangible, physical media implemented in technology for storage of information, such as computer readable instructions, data structures, program modules, or other data. By way of example, and not limitation, such non-transitory computer-readable media can include random access memory (RAM), read-only memory (ROM), electronically erasable programmable ROM (EEPROM), compact disc ROM (CD-ROM), digital versatile disks (DVD) or other optical disk storage, magnetic disk storage or other magnetic storage devices, or any other tangible, physical medium that can be used to store desired program code in the form of instructions, information, or data structures and that can be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

According to the teachings of the present disclosure there is provided a health hazards geolocation control system for monitoring and maintaining potential health hazards endangering a user using the system, the system including a remote geolocation-server; a user warning-device coupled with each user; a health hazards geographic map; and a user's-module configured to communicate with at least one user warning-device,

The health hazards geographic map includes dynamically mapped potential health hazards (PHHs), wherein each PHH is assigned a safety score; the remote geolocation-server is configured to provide the user warning-device with a regional segment of the health hazards geographic map based on location received from the remote geolocation-server; and the user warning-device is configured to alert the coupled user or others upon approaching at least one PHH. Typically, with no limitations, the user is a pedestrian.

The safety score of a PHH may be rated on a preconfigured hazard-scale that includes at least two types of PHHs.

The remote geolocation-server is configured to manage, update, report PHHs and generate safe path plan using a geolocation or Geographic Information System (GIS), upon receiving a request from a user warning-device.

Upon the pedestrian user being a person that carries a none-human subject selected from a group including bacteria, fungal, virus and astrobiology mater, the pedestrian user reports his/her PHH state, being a mobile PHH, to the remote geolocation-server, to thereby facilitate real-time and future avoidance of the mobile PHH by other users.

In some embodiments, the user warning-device may further include at least one image sensor; and a memory unit, wherein the image sensor is adapted to be worn by a user or to be carried by a selfie-drone associated with the user, such that images captured by the image sensor represent the surroundings of the user. The processing unit is configured to store the captured images in the memory unit. Upon the user identifying a PHH in the pathway of the user, the user reports and sends one or more captured images of the PHH to the remote geolocation-server.

According to the teachings of the present disclosure there is provided an independent, personal health hazards monitoring system, wherein the user warning-device includes at least one image sensor; a memory unit; and a processing unit for processing images. The image sensor is adapted to be worn by a user or to be carried by a selfie-drone associated with the user, such that images captured by the image sensor represent the surroundings of the user. The processing unit is configured to store the captured images in the memory unit, and is further configured to process the captured images to thereby detect one or more PHHs in the pathway of the user, during movement of the user, which health hazards may cause a stumble or the fall of the user.

A safety/danger-score of a PHH is calculated, based on paraments including the type of PHH, size, unlevel, angle, un-stable, slipped surface, contrast, moving object, approaching speed, the time of day, the total number of occurrences, duration from appearing, re-occurrence, number of occurrence by the same user and number of occurrences by other users. The processing unit is further configured to alert the user upon detecting at least one PHH.

Typically, the safety score of a PHH is rated on a preconfigured hazard-scale that includes two or more of the various PHHs.

The processing unit of the personal health hazards monitoring system may be configured to provide the user with instruction as to how to conduct his/her movements in order avoid encountering the detected PHH, and wherein the instruction include suggesting a stop of movement, slowing down of walk or a preferred walking deviation path to detour the detected PHH. A pedestrian user of the personal health hazards monitoring coupled with a tactile-related device may receive an automatic alert, wherein the alert is an automatic tactile sensing alert.

The personal health hazards monitoring system may be configured to interact with a health hazards geolocation control system for monitoring and maintaining potential health hazards endangering pedestrians using the system. The health hazards geolocation control system includes a remote pedestrians-server; a user warning-device coupled with each pedestrian user; a health hazards geographic map; and a users-module configured to communicate with at least one user.

The health hazards geographic map includes dynamically mapped potential health hazards (PHHs), wherein each PHH is assigned a safety score. The remote pedestrians-server is configured to provide the user warning-device with a regional segment of the health hazards geographic map based on location received from the remote pedestrians-server, wherein the user warning-device is configured to alert the coupled pedestrian user upon approaching at least one PHH.

In this embodiment, the remote pedestrians-server may be configured to manage, update, report PHHs and generate safe path plan using a Geographic Information System (GIS), upon receiving a request from a pedestrian user.

In this embodiment, upon the pedestrian being a persons that carries a none-human subject selected from a group including bacteria, fungal, virus and astrobiology mater, the pedestrian user reports his/her PHH state, being a mobile PHH, to the remote pedestrians-server, to thereby facilitate real-time and future avoidance of the mobile PHH by other pedestrian users.

According to the teachings of the present disclosure there is provided a personal health hazards monitoring method for detecting health hazards. The method includes the following steps:
a. providing a personal health hazards monitoring system as in claim 7;
b. processing images captured by the image sensor to detect an occurrence of at least one PHH;
c. calculating a safety/danger-score of a PHH based on paraments including the type of PHH, size, unlevel, angle, un-stable, slipped surface, contrast, moving object, approaching speed, the time of day, the total number of occurrences, duration from appearing, re-occurrence, number of occurrence by the same user and number of occurrences by other users; and
d. upon detecting the at least one potential health hazards, alerting the user of the detected PHH.

The health hazards monitoring method may further include the step:
e. providing the user with instruction as to how to conduct his movements in order avoid stumbling over the detected PHH.

Upon detecting two or more potential health hazards, the hazardous obstacle monitoring method further includes the step of discriminating between the detected potential health hazards, using a preconfigured danger-scale that predefines the danger level of potential health hazards.

Optionally, the alerting is performed automatically using a tactile-related device, wherein the tactile alert may be in the form of a vibration or other tactile sensing to the foot that mimics the feeling of an unbalanced safe step, that results with a quick stop of the user and maintaining the full body weight on the table foot.

The alerting may be transmitted to a remote center by wireless or by other communication means.

The alerting is transmitted to a typically cloud based health hazards geolocation control system and/or data storage, typically a by wireless or by other communication means.

The detected PHH detection may include detecting a falling incident or a near-falling incident of the user, wherein the detecting of a falling incident or a near-falling incident of the user may use image frames captured by the image sensor flown by the drone.

The health hazards monitoring method of claim 15, wherein the health hazards monitoring system is at least partially embodied on a personal mobile device.

The user may be a person, an animal or a none-human subject, on earth or on other planets.

each of the persons carrying a contagious virus may be reported to either the health hazards monitoring system, or to a health hazards geolocation control system or both, by the person or by a third party.

According to the teachings of the present disclosure there is provided a health hazards geolocation control method for monitoring and maintaining potential health hazards endangering users, the method including the steps of:
a. providing a personal health hazards monitoring system;
b. receiving a desired geographical motion path from a user warning-device of a user;
c. providing, by the remote geolocation-server to the user warning-device, at least one regional segment of the health hazards geographic map based on the desired geographical motion path received from the user warning-device; and d. upon approaching at least one PHH the user warning-device alerts the user.

### BRIEF DESCRIPTION OF THE DRAWINGS

The present disclosure is herein described, by way of non-limiting example, with reference to the accompanying drawings. With specific reference now to the drawings in detail, it is stressed that the particulars shown are by way of example and for purposes of illustrative discussion of the embodiments of the present disclosure only, and are presented in order to provide what is believed to be the most useful and readily understood description of the principles and conceptual aspects of the present disclosure. In this regard, no attempt is made to show structural details of the present disclosure in more detail than is necessary for a fundamental understanding of the present disclosure, the description taken with the drawings making apparent to those skilled in the art how the several forms of the present disclosure may be embodied in practice. In the figures:

FIG. 1 is a general schematic block diagram illustration of components of a health hazards geolocation monitoring control system, according to embodiments of the present disclosure, the system including a personal health hazards monitoring sub-system.

FIG. 2 depicts a user of the personal health hazards monitoring system, having an image sensor, according to embodiments of the present disclosure, wherein the image sensor is mounted on a hip belt.

FIG. 3 depicts a hip level view of a scenery as viewed by the image sensor of the personal health hazards monitoring system, wherein, in the exampled shown, the system has determined that the viewed pathway is safe, as annotated, in the exampled shown, in green markings.

FIG. 4a depicts a top view of a user approaching an example health hazard, annotated in green/orange/red markings of a danger conventional scale, taken from a selfie drone.

FIG. 4b depicts a top view of the user approaching an example health hazard, wherein the user is closer to the obstacle taken from a selfie drone.

FIG. 4c depicts a top view of the user approaching an example health hazard, wherein the user is getting near to the obstacle, taken from a selfie drone.

FIG. 5a depicts the user getting near to the obstacle, as viewed from the obstacle zone, the obstacle being a small crater formed in the pavement.

FIG. 5b depicts the user starting to move sideways of the obstacle, in order to bypass the obstacle.

FIG. 6a depicts a top view of the user, optionally after receiving instructions, moving sideways, away from the obstacle, in order to bypass the obstacle.

FIG. 6b depicts a top view of the user after he/she has moved sideways, and continued his/her walk safely.

FIG. 7 depicts a near pavement level view of a user near another type of obstacle, the obstacle being a prominent obstacle sticking out of the pavement.

FIG. 8a depicts a near pavement level view of the user and the obstacle shown in FIG. 7, the user receiving a warning, in order to move sideways of the obstacle, in order to avoid the obstacle.

FIG. 8b depicts the worn user beginning to move sideways of the obstacle, in order to avoid the obstacle.

FIG. 9a depicts a belt level view of a user approaching another example health hazard.

FIG. 9b depicts a belt level view of the user getting closer to the obstacle shown in FIG. 9a.

FIG. 10 shows a schematic flowchart diagram of a personal health hazards monitoring method, according to some embodiments of the present disclosure.

FIG. 11 depicts an example safe path planning for a user situated at geographical location A and desires to reach geographical location B.

FIGS. 12a-12c are respectively exemplary screenshots of a personal mobile application, according to at least some embodiments of the present disclosure, wherein the personal health hazards monitoring system is at least partially embodied on the personal mobile device.

FIGS. 13a-13b are respectively exemplary screenshots of a webserver application for managing the users of the personal health hazards monitoring system of the present disclosure, according to at least some embodiments of the present disclosure.

FIG. 14 shows a schematic flowchart diagram of a health hazards geolocation control method, according to some embodiments of the present disclosure.

FIG. 15 depicts an example guide dog, carrying an optical camera device of the personal health hazards monitoring system of the present disclosure, according to some embodiments of the present disclosure.

### DETAILED DESCRIPTION OF THE INVENTION

The present disclosure will now be described more fully hereinafter with reference to the accompanying drawings, in which the preferred embodiments of the disclosure are shown. This disclosure may, however, be embodied in many different forms and should not be construed as limited to the embodiments set forth herein; rather, these embodiments are provided, so that this disclosure will be thorough and complete, and will fully convey the scope of the disclosure to those skilled in the art.

An embodiment is an example or implementation of the disclosures. The various appearances of “one embodiment,” “an embodiment” or “some embodiments” do not necessarily all refer to the same embodiments. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily in all embodiments, of the disclosures. It is understood that the phraseology and terminology employed herein is not to be construed as limiting and are for descriptive purposes only.

Methods of the present disclosure may be implemented by performing or completing manually, automatically, or a combination thereof, selected steps or tasks. The order of performing some methods step may vary. The descriptions, examples, methods and materials presented in the claims and the specification are not to be construed as limiting but rather as illustrative only.

Meanings of technical and scientific terms used herein are to be commonly understood, unless otherwise defined. The present disclosure can be implemented for testing or practice with methods and materials equivalent or similar to those described herein.

Throughout this document, numerous textual and graphical references are made to trademarks, and domain names. These trademarks and domain names are the property of their respective owners, and are referenced only for explanation purposes herein.

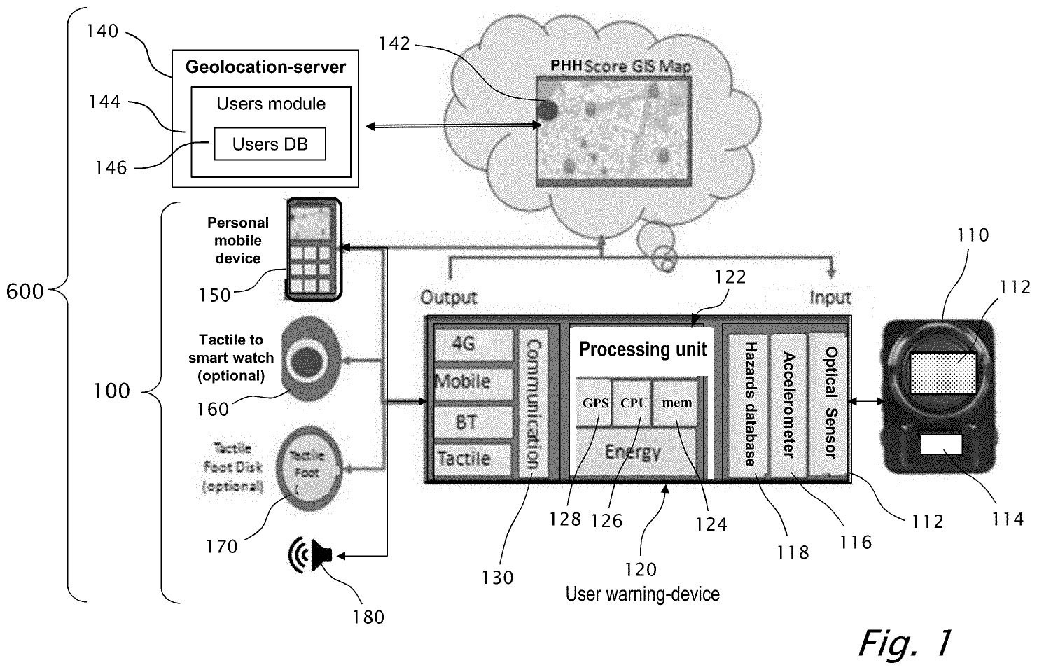

Reference is now made to the drawings. FIG. 1 is a schematic block diagram illustration of the components of a personal health hazards monitoring system 100, according to embodiments of the present disclosure, including optical camera device 110 having an image sensor 112 and optionally other sensors such as a laser based sensor or an IR camera 114. The personal health hazards monitoring system 100 further includes a user warning-device 120 having a processing unit 122, a communication module 130, adapted to receive data at least from image sensor 112, and a movements detection sensor such as an accelerometer 116, and communication module 130 is further adapted to transmit a warning to the user. The personal health hazards monitoring system 100 further includes a warning device coupled with the user, adapted to at receive a warning for the user, for example a speaker 180, a personal mobile device 150, a personal smart watch 160 and/or a foot bracelet or tactile in a shoe disk form 170. The warning may be in an audible, visual and/or tactile form, or any combination thereof. A visual alert may be in the form of a display, lights, flashing, blinking, smart eyeglasses projection or other visual warning forms known in the art. A tactile alert may be in the form of a vibration or other tactile sensing to the foot that “mimic the feeling of an unbalanced safe step” that results with a quick stop of the user and maintaining the full body weight on the table foot. Typically, with no limitations, the alert is automatic and is generated about 4-5 steps from the PHH, and if the user does not respond the alert level may become intensified as the PHH becomes nearer.

In some embodiments, personal health hazards monitoring system 100 is integrated into a single device, for example, without limitations, using PSoC technology, with or without the alarm device. The communication module 130 may use wired communication, wireless communication, mobile, Bluetooth, satellite, communications modes or a combination thereof.

User warning-device 120 includes a processing unit 122 having a CPU 126 coupled to operate with a memory unit 124, and an energy source. Processing unit 122 may be local, remote or a combination thereof.

Optical camera device 110 maybe a wearable device, for example, mountable on the hip belt of the subject, embedded in any kind of natural or synthetic fibers, filaments (e.g. cloth) and/or similar material, including glass, metal or combinations of any of the mentioned here such that images captured by said image sensor represent the surroundings of the user subject. Alternatively, or in addition to, optical camera device 110 may be carried by a selfie-drone associated with the user subject, such that images captured by said image sensor represent the surroundings of the user subject.

Preferably, personal health hazards monitoring system 100 further includes a geographical location device, such as a GPS 128, Wi-Fi, Vector mobile phone positioning system inertial navigation system (INS) indoor positioning system (IPS), shared sensor community Navigation Information System (NIS), configured to calculate and transmit the current geographical location of the user subject, or a combination thereof.

Image sensor 112 is adapted to be worn by a user subject or to be carried by a selfie-drone associated with the user subject, such that images captured by said image sensor represent the surroundings of the user subject. Processing unit 122 of user warning-device 120 is configured to store the captured images in memory unit 124. Processing unit 122 is further configured to process the captured images to thereby detect one or more potential hazardous pedestrian obstacles in the pathway of the user subject, during movement of the user subject, which health hazards may cause a stumble or the fall of the user subject. User warning-device 120 is further configured to alert the user subject upon detecting at least one potential PHH.

In some embodiments of the present disclosure, personal monitoring system 100 includes a local database 118 for storing, some of which data may be stored either in memory unit 124 or in an users DB 146 of a remote geolocation-server 140 or at both locations. For example, each user 20 has a movements profile that is typically, with no limitations, kept in the local memory unit 124. Such a portfolio may include illnesses that affect user's 20 movements, for example Parkinson's Disease. Such a portfolio may include the steps sizes of user subject 20 that are used to determine how many steps will take to reach a known or detected health hazard 99, situated ahead of user subject 20. Data containing a geographical map of urban public space, on which map of known potentially health hazards 99 are mapped, is typically, with no limitations, kept in a remote geolocation-server, such as remote geolocation-server 140, in a GIS based database 142.

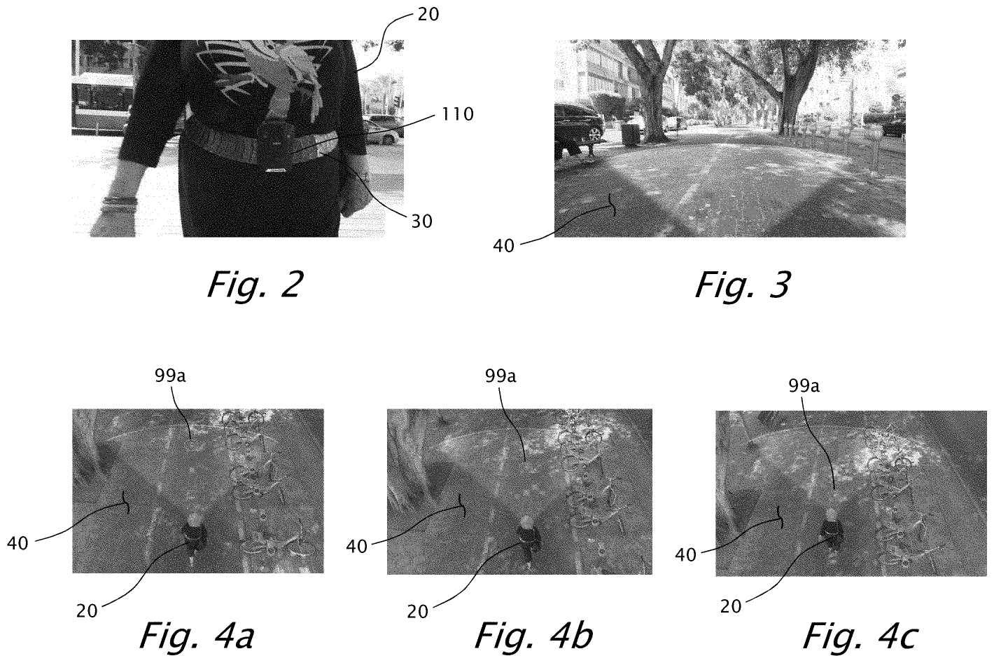

Reference is now also made to FIG. 2, depicting a user subject 20 of the personal health hazards monitoring system 100, according to embodiments of the present disclosure, wherein optical camera device 110 is mounted on a hip belt 30.

FIG. 3 depicts a hip level view of a scenery as viewed by image sensor 112 of the personal health hazards monitoring system 100, wherein, in the exampled shown, system 100 has determined that the viewed pathway is safe, as annotated, in the exampled shown, in green markings. FIG. 4a depicts a top view of a user 20 approaching an example health hazard 99a, annotated in green/orange/red markings of a danger conventional scale, taken from a selfie drone (not shown).

It should be noted that the green/orange/red conventional danger markings are used here for illustrative purposes only. However, in some embodiments of the present disclosure, such warning annotations may be present to the user, for example, as an image projection on smart glasses worn by user 20, or displayed on any other personal device such as personal mobile device 150 and/or personal smart watch 160.

In FIG. 4a user 20 is shown approaching an example health hazard 99a, taken from a selfie drone (not shown), annotated in green/orange/red markings of a danger conventional scale, wherein the green area is quite substantial, indicating that user 20 is still in safe territory (green). FIG. 4b depicts user 20 getting closer to a health hazard being a hazardous obstacle 99a, and FIG. 4c depicts user 20 is getting near to the dangerous territory (red).

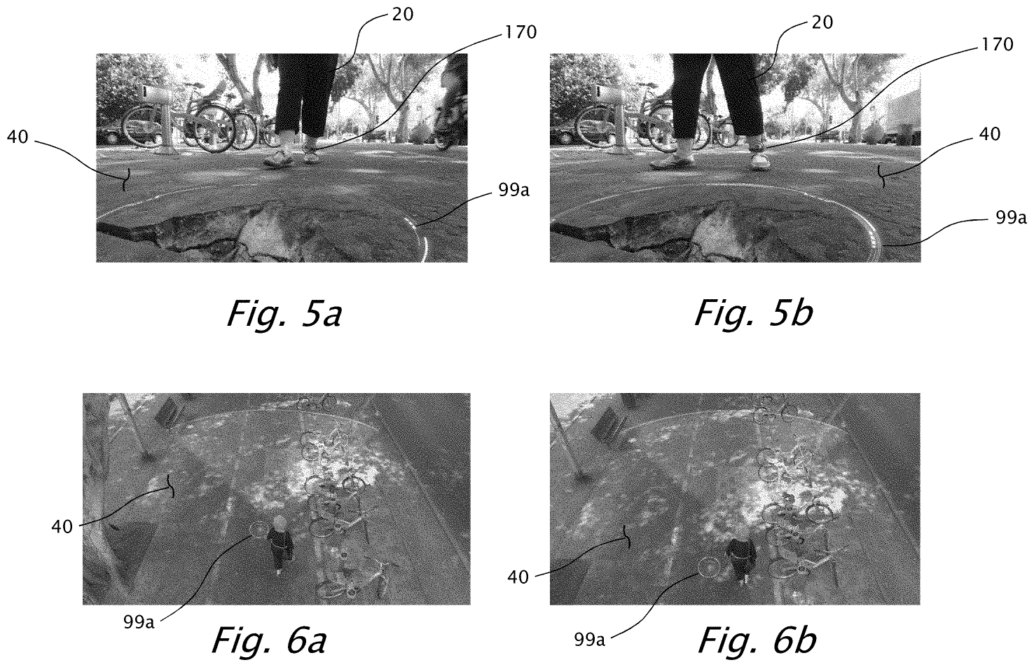

FIG. 5a depicts user 20 getting near to the obstacle 99a, as viewed from the obstacle zone, obstacle 99a being a small crater formed in the pavement 40. In this example, user 20 also wears a tactile foot bracelet 170, configured to receive warning signals from processing unit 122 and automatically activate a tactile signal on the user's skin. FIG. 5b depicts user 20 starting to move sideways of the obstacle 99a, in order to bypass the obstacle 99a. FIG. 6a depicts user 20, optionally after receiving instructions, moving sideways, away from obstacle 99a, in order to bypass the obstacle 99a. FIG. 6b depicts user 20 after he/she has moved sideways and continued his/her walk safely.

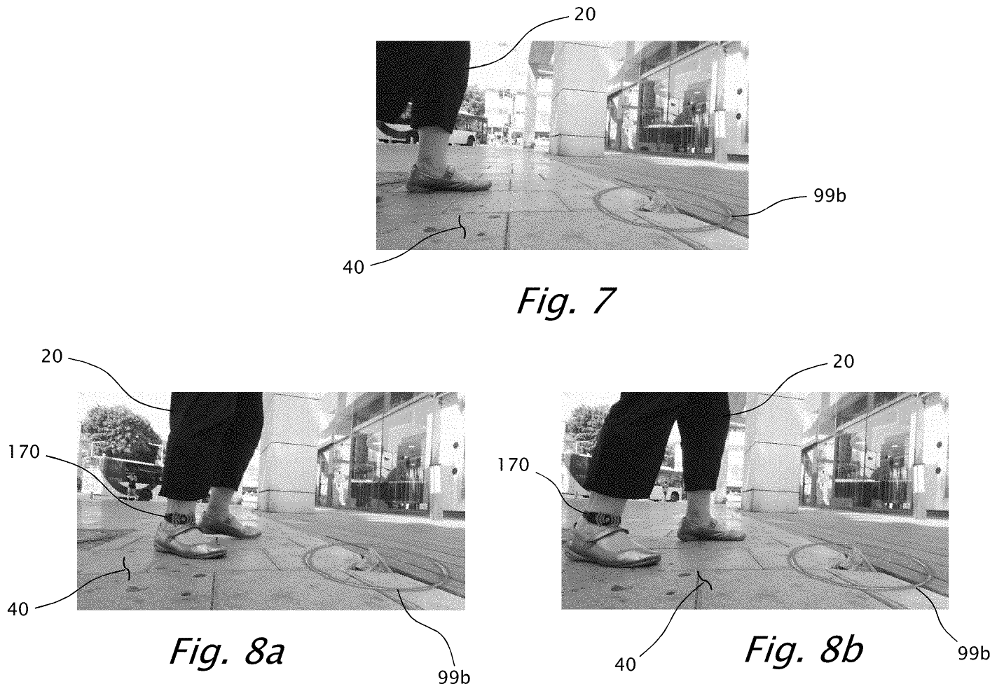

FIG. 7 depicts a near pavement level view of a user 20 near another type of a health hazard being a hazardous obstacle 99b, obstacle 99b being a prominent obstacle sticking out of the pavement 40. FIG. 8a depicts user 20, in a near pavement level view, near obstacle 99b, wherein user is receiving an automatic warning via tactile foot bracelet 170, in order to move sideways of obstacle 99b, in order to avoid obstacle 99b. FIG. 8b depicts user 20 beginning to move sideways, away from obstacle 99b, in order to avoid obstacle 99b.

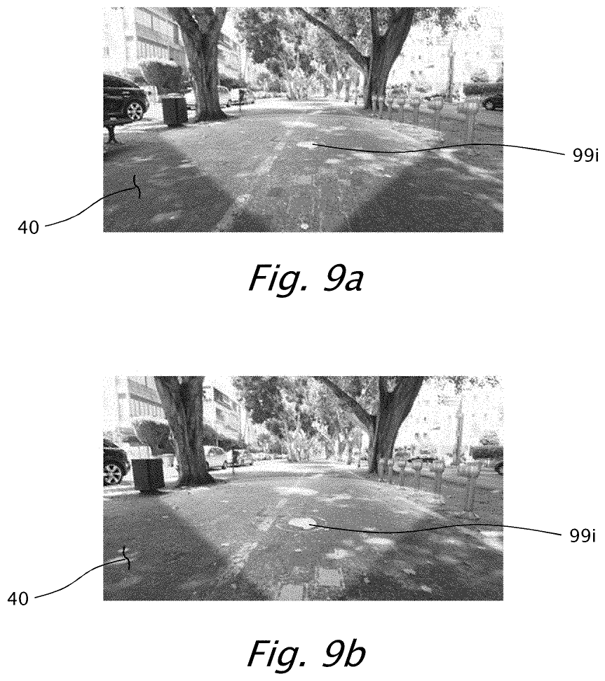

FIG. 9a depicts a belt level view of a user 20 approaching another example health hazard 99i. FIG. 9b depicts a belt level view of the user 20 getting closer to obstacle 99i.

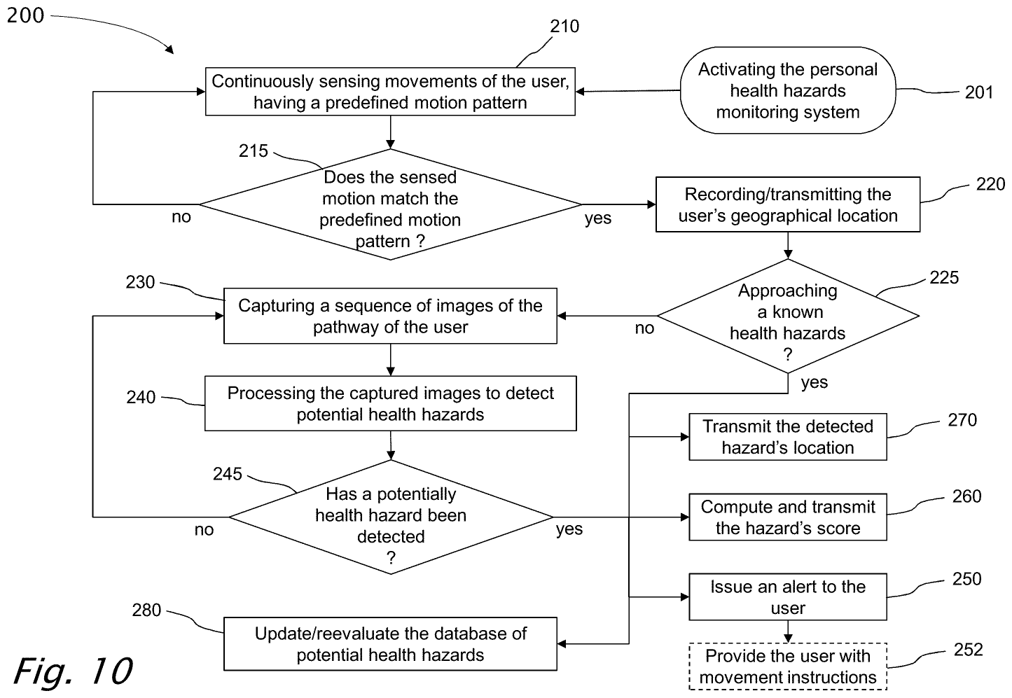

Reference is now also made to FIG. 10, showing a schematic flowchart diagram of a health hazards monitoring method 200, according to some embodiments of the present disclosure, wherein method 200 is operable upon activation of personal health hazards monitoring system 100 (Step 201), coupled to operate with a particular user 20, having a predefined motion pattern. Health hazards monitoring method 200 proceeds as follows:

Step 210: continuously monitoring/sensing movements of the user, having a predefined motion pattern.

Processing unit 122 of user warning-device 120 continuously monitors movements of the user, having a predefined motion pattern, as kept and updated in his/her stored personal portfolio.

Step 215: checking if the sensed motion matches the predefined motion pattern.

Processing unit 122 continuously checks if the sensed motion matches the predefined motion pattern as defined in his/her stored personal portfolio.

Step 220: recording and/or transmitting the user's geographical location.

Processing unit 122 records in memory unit 124 and/or transmits to remote geolocation-server 140 the user's geographical location, as obtained from GPS 128.

Step 225: checking if approaching a known health hazard.

Processing unit 122 checks in local database 118 and/or in GIS based database 142 if the user's geographical location and his/her path of motion leads towards a known potential health hazard (PHH) 99.

If the user's geographical location and his/her path of motion leads towards the known PHH 99, go to Step 250.

Step 230: capturing a sequence of images of the pathway of the user.

Processing unit 122 activates optical camera device 110 to thereby capture a sequence of images of the pathway of the user.

Step 240: processing the captured images to detect potential health hazards.

Processing unit 122 processes the captured images to detect potential health hazards 99, if such hazards 99 do exist in the pathway of the user.

Step 245: checking if a potentially health hazard has been detected.

Processing unit 122 checks if a potentially health hazard has been detected and if user subject 20 approaches the detected health hazard 99.

If a potentially health hazard has been detected and it has been determined that user subject 20 approaches, in a collision course, the detected health hazard 99, continue with Step 250.

Else, go back to Step 230.

Step 250: issue an alert to the user subject.

Processing unit 122 has determined that user subject 20 approaches, in a collision course, a health hazard 99.

Therefore, processing unit 122 issues an alert to user subject 20. The warning can be in any way known in the art, including using a speaker 180, a personal mobile device 150, a personal smart watch 160 and/or a foot bracelet 170. The warning may be in an audible, visual and/or tactile form.

Step 252: optionally, provide the user with movement instructions.

Processing unit 122 may provide a user 20 with movement instructions, in order to move away from the obstacle 99 and thereby safely bypass health hazard 99.

Step 260: compute and transmit the hazard's score.

Processing unit 122 evaluates health hazard 99 to thereby determine a danger score of that health hazard 99 on a predefined danger scale.

Processing unit 122 may then transmit the determined danger score associated with that health hazard 99 to remote geolocation-server 140 and/or local database 118.

Step 270: transmit the location of the health hazard.

Processing unit 122 may transmit the location of that health hazard 99 to remote geolocation-server 140 and/or local database 118.

Step 280: update/reevaluate the database of potential health hazards.

Processing unit 122 updates and/or reevaluate the database of potential health hazards 99, including in local database 118 and/or in GIS based database 142.

Go back to Step 210.

Step 299: exit.

(end of health hazard monitoring method 200)

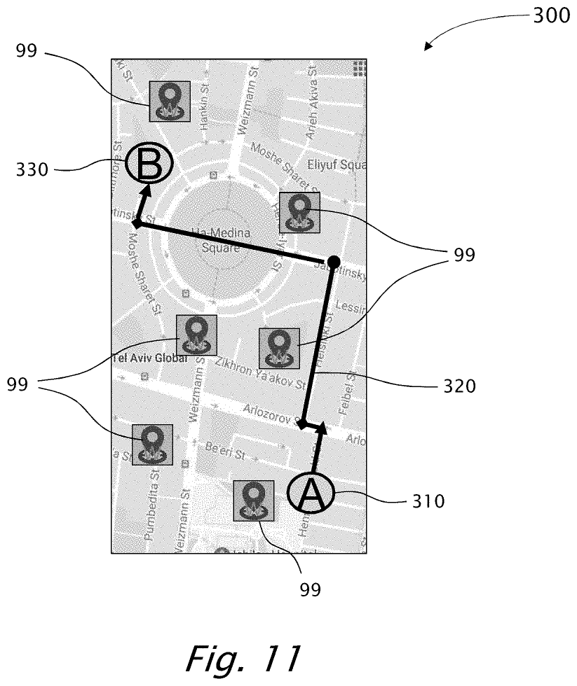

Reference is now made to FIG. 11, depicting an example safe path (320) planning (300) for a user situated at geographical location A (310) and desires to reach geographical location B (330). The processing unit 122 of the user warning-device 120 is adapted to calculate, for the user, a safest pathway 320 leading from location A (310) to location B (330) without the worrying of crossing known health hazards 99. At the same time, when approaching a zone with known health hazards, the personal health hazards monitoring system 100 may alert the user to increase his/her awareness. By generating a virtual GIS health hazards map, the system knows to alert and avoid known obstacles 99, for example, by imbedding the concept of Foreign Object Debris (FOD) technology. The system may also capture Almost Falls Events (AFE) that may be utilized as well.

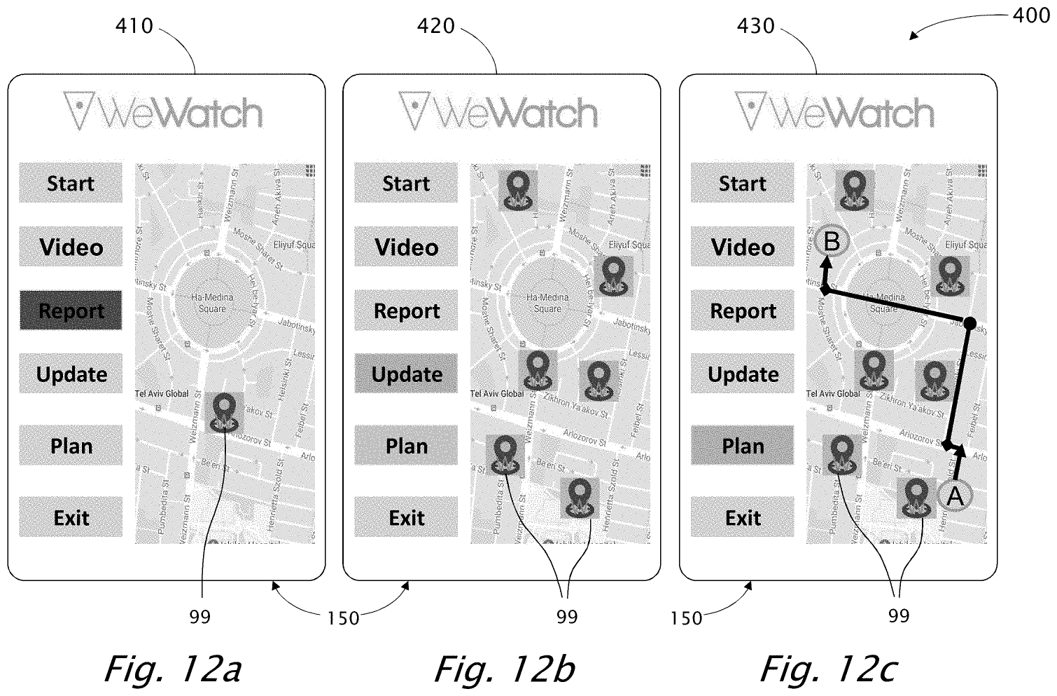

Reference also to FIGS. 12a-12c respectively showing exemplary screenshots 410, 420 and 430, of a personal mobile application, according to at least some embodiments of the present disclosure, wherein personal health hazards monitoring system 100 is at least partially embodied on the personal mobile device 150.

FIG. 12a depicts a situation where the health hazard detection and monitoring algorithm has detected a PHH 99, associated with the user's geographical location, maps the detected on the local geographical map, as depicted, displays the map on the display on the personal mobile device 150, as depicted, and reports that information to the database of mapped health hazards enables.

FIG. 12b depicts a situation in which the map of known health hazards in the user's geographical location, are displayed on the personal mobile device 150 of the user.

FIG. 12c depicts a situation in which user situated at geographical location A (310) and desires to reach geographical location B (330) as described here above with association to FIG. 11 By activating the “Plan” button, the health-hazard-detection-and-monitoring algorithm computes a safest pathway 320 leading from location A (310) to location B (330), which path is displayed on the personal mobile device 150 of the user.

In variations of the present disclosure, when a user approaches a known obstacle 99, as informed by a health hazards geolocation control system 600 (see FIG. 1), and processing unit 122 of user warning-device 120 determines that no PHH exists at the given location, the health hazards detection and monitoring algorithm reports that information to remote geolocation-server 140 to thereby facilitate the update of the GIS based database 142 of health hazards geolocation control system 600.

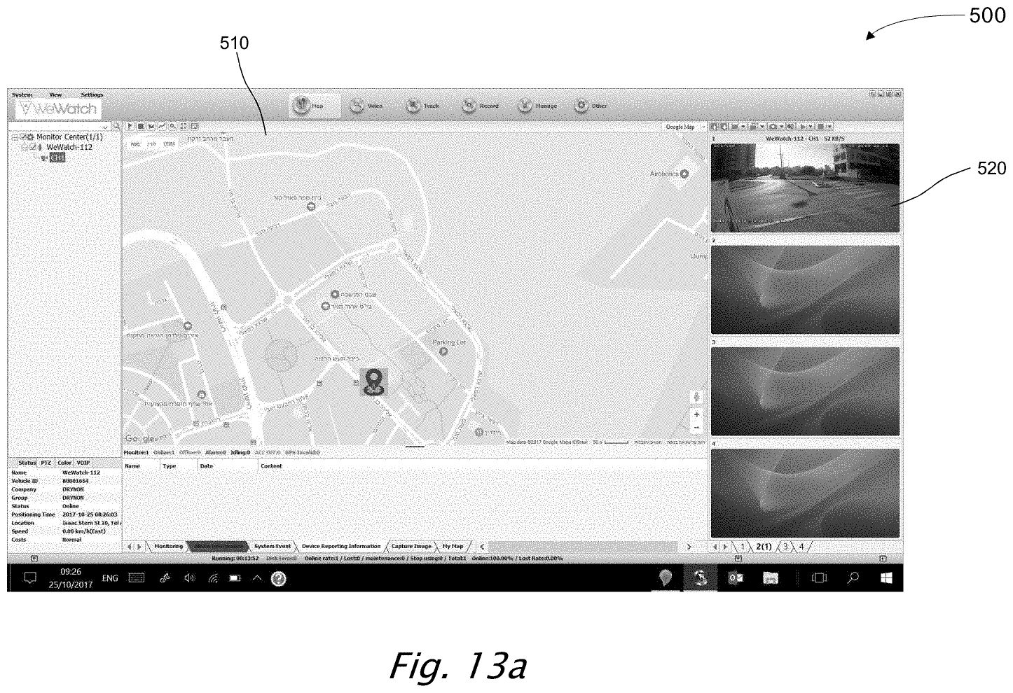

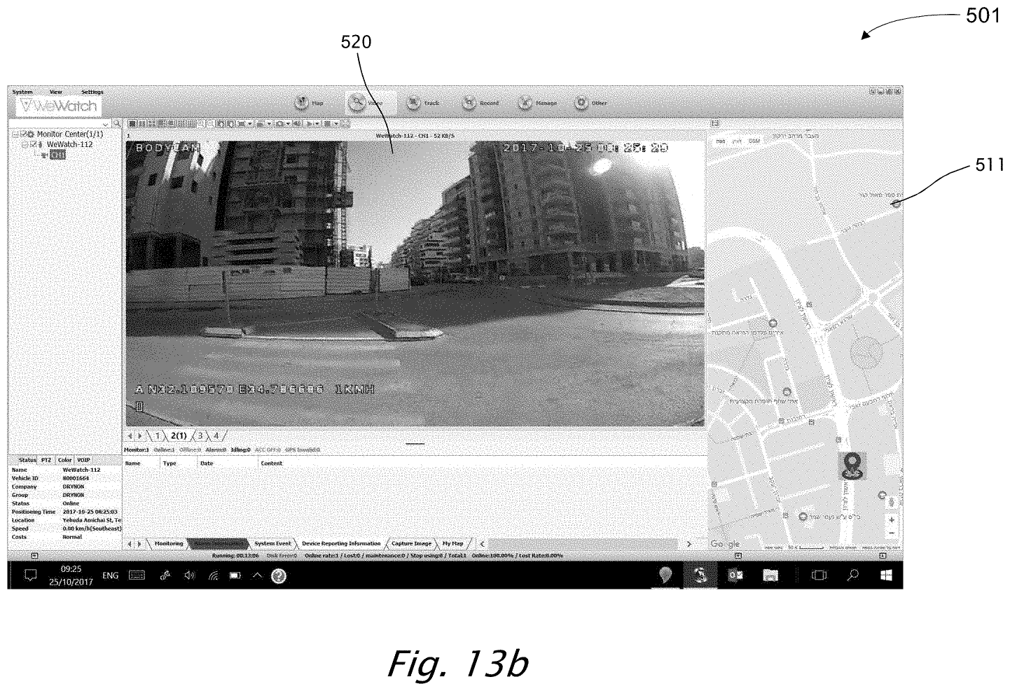

FIGS. 13a-13b are respectively exemplary screenshots of a webserver application for managing the users of the health hazards monitoring system of the present disclosure, according to at least some embodiments of the present disclosure.

FIG. 13a showing the geographical location of all currently active users 20 on a map segment 510, a list of users, with no limitations, on the righthand side of the screen, wherein the view (520) from the camera (110) of the only active user is shown. When selecting an active user 20, with reference to FIG. 13b, the example depicts on webserver application screen 501, shows the view from the camera (110) of that user is shown in the main window, and the map (511), showing the location of that user, is shown in a secondary window.

The webserver application may be a cloud base web application to manage, service and monitor the active health hazards monitoring systems.

The webserver application may be used by users, organizations, agencies, city or national teams responsible to monitor, allocate or fix public PHHs. as a tool to prioritize their tasks.

The cloud base database can be used to generate big data analyses, which may provide new information not known currently like what kind of users fall where, when, from what and other matrix parameters which may have value and can be utilized in Geolocation Data directly between activated users.

The processing unit 122 of the personal health hazards monitoring system 100 is further configured to locate, map, update and declare hot spots of health hazards through a Geographic Information System (GIS) designed to locate, analyze and present spatial geographic health hazards data in the indoor or outdoor environments, private, public, country side or urban locations, the data kept in a database. Such a database of mapped health hazards enables to advise the best pathway for a walk/run with minimal potential for health hazard events, for example, by providing a safety score for the selected pathway. Such a database of mapped health hazards data in the geographic public space may also be used by government authorities for mending and removing such health hazards. In some embodiments, the geographic health hazards data in the urban public space is built manually.

In the consideration for PHH obstacle safety/danger, many parameters are taken into account in formulating the function to achieve an accurate scale of PHH scores, including, for example, the type, size, unlevel, angle, un-stable, slipped surface, contrast, moving object, approaching speed, up to 5 steps away. Moreover, the time of day of total number of occurrences, duration from appearing, re-occurrence, number of occurrences by the same user, number of occurrences by other users. On top of this the personal risk, Morse fall scale and historical score which are taken into account to calculate the PHH score.

The PHH score may be refined base on the health-related conditions of the user receiving the PHH score. For example, visually impaired person vs. a sighted person, a young person vs. a senior citizen, a well walking person vs. a person using a walker, healthy vs. infected or sick person, animal, none-human, etc.

Referring back to FIG. 1, a health hazards geolocation control system 600 for monitoring and maintaining potential health hazards endangering pedestrians using system 600. Health hazards geolocation control system 600 includes remote geolocation-server 140, user warning-device 120 coupled with each user 20, a GIS based database 142 including a health hazards geographic map with known dynamically mapped stationary PHHs, each coupled with a safety score, and an users-module 144 configured to communicate with at least one user warning device 120.

Remote geolocation-server 140 is configured to provide a user warning-device 120 with a regional segment of the health hazards geographic map based on location received from the remote geolocation-server 140 via users-module 144. The user warning-device 120 is configured to alert the coupled user 20 or others upon approaching at least one PHH. It should be appreciated that the alert is issued, in the above embodiment, without the need for warning-device 120 to carry or activate an image sensor 112.

The safety score of a PHH can be rated on a preconfigured hazard-scale that includes at least two types of PHHs.

The remote geolocation-server 140 is configured to manage, update, report PHHs and generate safe path plan using a geolocation or Geographic Information System (GIS), upon receiving a request from a user warning-device 120.

Upon a pedestrian user 20, being a person that carries a none-human subject selected from a group including bacteria, fungal, virus and astrobiology mater, for example a Corona virus, the pedestrian user 20 may reports his/her PHH state, being a mobile PHH, to the remote geolocation-server 140, to thereby facilitate real-time and future avoidance of the mobile PHH by other users 20. It should be appreciated that a mobile PHH can be blocked when entering into specific zones, services, stores. For example, if a mobile PHH is screened to a positive harm factor, a medical clinic or commercial zone may request from the mobile PHH not to enter by a verbal order from, a safety user official or an electronic system.

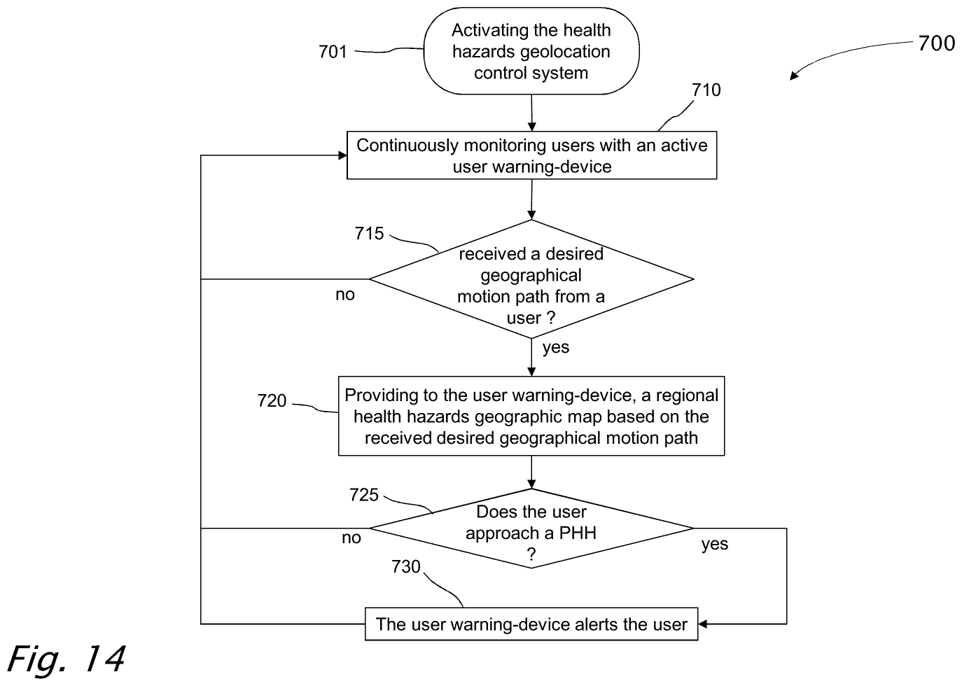

Reference is now also made to FIG. 14, showing a schematic flowchart diagram of a health hazards geolocation control method 700, according to some embodiments of the present disclosure, wherein method 700 is operable upon activation of at least one personal health hazards monitoring system 100 (Step 701), coupled to operate with a particular user 20, having a predefined motion pattern. Health hazards geolocation control method 700 proceeds as follows:

Step 710: continuously monitoring/sensing movements of the user, having a predefined motion pattern.

Remote geolocation-server 140 of health hazards geolocation control system 600 continuously monitors movements of active users 20 via respective user warning-devices 120.

Step 715: checking if a received a desired geographical motion path from a user.

Users module 142 checks if received a desired geographical motion path from the user warning-devices 120 of a particular user 20.

if a desired geographical motion path from a user warning-device 120 of a particular user 20 was not received return to Step 710.

Step 720: the remote geolocation-server transmits the regional health hazards geographic map to the user.

If a desired geographical motion path from a user warning-device 120 of a particular user 20 has been received by users module 142, geolocation-server 140 transmits a respective regional health hazards geographic map, based on the received desired geographical motion path, back to the respective warning-device 120.

Step 725: checking if a potentially health hazards is approached by the user.

Remote geolocation-server 140 of health hazards geolocation control system 600 checks the user approach a PHH.

If a potentially health hazards is being approached by the user subject 20, in a collision course, the detected health hazards 99, continue with Step 730.

Else, go back to Step 710.

Step 730: issue an alert to the user subject.

Remote geolocation-server 140 (or processing unit 122) has determined that user subject 20 approaches, in a collision course, a health hazard 99.

Remote geolocation-server 140 (with/or processing unit 122) issues an alert to user subject 20. The warning can be in any way known in the art, including using a speaker 180, a personal mobile device 150, a personal smart watch 160 and/or a foot bracelet 170. The warning may be in an audible, visual and/or tactile form.

(end of health hazards monitoring method 700)

It should be appreciated that the user warning-device 120 may further include at least one image sensor 112 and a memory unit 124, wherein the image sensor 112 is adapted to be worn by the coupled user 20 or to be carried by a selfie-drone associated with the user, such that images captured by the image sensor 112 represent the surroundings of user 20. The processing unit 122 is configured to store the captured images in memory unit 124.

Upon user 20 identifying a PHH in his/her pathway, user 20 may report/send one or more captured images of the PHH to the remote geolocation-server 140.

A webserver application may be a cloud base mobile or web application for the user to manage, update, report PHHs and generate safe path plan. The webserver application may retrospectively allocate in which incidents the user had fallen, for example, where the system did not detect the PHH. By recalculating the images, the machine learning system can calibrate the methods and update the calculating logarithms and scoring of the PHH.

The health hazards monitoring system may be utilized by a leader or an accompanied accompanier to a user or a group of users. For example, a walking guided tour of elderly people can wear and activate the health hazards monitoring system on his/her belt while touring with the group. Although he/her may not fall from a set of predefined PHH the health hazards monitoring system can bring to his/her attention potential risks for the group in real-time, which can be even transmitted to a specific user in the group or to all group members which fits to a PHH definition.

In the same manner this can be used in family trips and other activities while one member my benefit from the health hazards monitoring system.

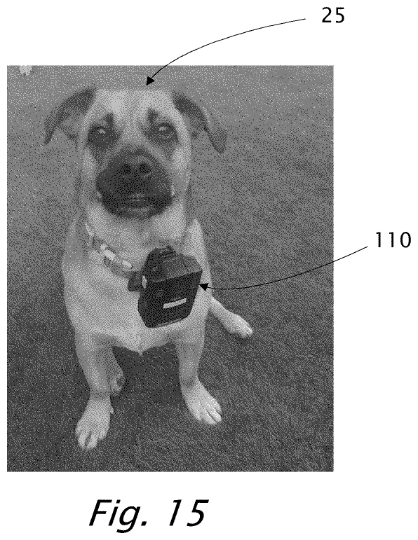

In a similar manner the optical camera device 110 of the personal health hazards monitoring system (100) can be attached to a service guide dog (25)/horse/dolphin/any other animal, as shown by way of example in FIG. 15, that can feel, for example, a vibration alarm for predefined PHHs. Animal 25 may be tamed by their master, during a training process, to act in response to the alarm, for example to stop in place. This is an advanced digital toolbox for handling hazardous objects that the service guide dogs (25)/horses/dolphins/any other animal are not trained for or not able to allocate.

Equestrian sports are one of the most popular forms of sport in many parts of the world which is considered as one of the most accident-prone sports. Furthermore, riding accidents are frequently associated with a high degree of severity of injuries and mortality. Nevertheless, there are insufficient data regarding incidences, demographics, mechanisms of accidents, injury severity patterns and outcome of injured persons in amateur equestrian sports. The health hazards monitoring system may be used to alert the rider when a predefined PHH can be safely crossed or not. Based on real-time monitoring of the achievement and abilities to jump the next barrier and alert the user if needed.

Although the present disclosure has been described with reference to the preferred embodiment and examples thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the following claims.

What is claimed is:

1. A health hazards geolocation control system for monitoring and maintaining potential health hazards endangering a user using the system, the system comprising:
a. a remote geolocation-server;
b. a user warning-device coupled with each user;
c. a health hazards geographic map; and
d. a users-module configured to communicate with at least one user warning-device,
wherein said health hazards geographic map comprises dynamically mapped potential health hazards (PHHs);
wherein each PHH is assigned a safety score;
wherein said remote geolocation-server is configured to provide the user warning-device with a regional segment of said health hazards geographic map based on location received from said remote geolocation-server; and
wherein said user warning-device is configured to alert the coupled user or others upon approaching at least one PHH.

2. The health hazards geolocation control system of claim 1, wherein said user is a pedestrian.

3. The health hazards geolocation control system of claim 1, wherein a PHH is selected from a group of hazards types, including:
a. fixed obstructions on pavements and pedestrian user movement like a walking paths including curbs, cracks, fissures, uneven grates, manholes, pits, slopes, uneven paving, sidewalk gutters that are insufficiently marked or too narrow, light rail or streetcar tracks, drainage grates and outdoor stairs;
b. temporary obstructions on pavements and user movement like a walking paths—piles of uncollected trash, fruits/vegetable peeling, fallen leaves, pools of water after heavy rain and low hanging branches or other overhanging decorative items;
c. pavement construction materials including bricks surface such as cobble stone surface, tactile pavement for the visually impaired;
d. multiple sources of traffic/busy intersections;
e. vehicles, including cars, motorcycles, bicycles fully or partially parked on walkways, cyclists, skateboarders, other electric transporter and other devices used by pedestrian, predefined excessive pedestrian crowding and small children;
f. animals and other none-human subjects;
g. persons or animals carrying none-human subjects selected from a group including bacteria, fungal, virus and astrobiology mater;
h. weather conditions selected from the group of conditions including rain, snow and ice;
i. light conditions, including daylight, dim light, poor lighting, darkness;
j. recreational areas; and
k. input from a mobile device that distracts the user from paying attention to a pathway.

4. The health hazards geolocation control system of claim 3, wherein the safety score of a PHH is rated on a preconfigured hazard-scale that includes at least two types of PHHs.

5. The health hazards geolocation control system of claim 1, wherein said remote geolocation-server is configured to manage, update, report PHHs and generate safe path plan using a geolocation or Geographic Information System (GIS), upon receiving a request from a user warning-device.

6. The health hazards geolocation control system of claim 3, wherein upon the pedestrian user being a person that carries a none-human subject selected from a group including bacteria, fungal, virus and astrobiology mater, the pedestrian user reports his/her PHH state, being a mobile PHH, to said remote geolocation-server, to thereby facilitate real-time and future avoidance of said mobile PHH by other users.

7. The health hazards geolocation control system of claim 1, wherein said user warning-device further comprises:
a. at least one image sensor; and
b. a memory unit,
wherein said image sensor is adapted to be worn by a user or to be carried by a selfie-drone associated with the user, such that images captured by said image sensor represent the surroundings of the user;
wherein said processing unit is configured to store said captured images in said memory unit;
wherein upon the user identifying a PHH in the pathway of the user, the user reports and sends one or more captured images of said PHH to said remote geolocation-server.

8. A personal health hazards monitoring system, wherein said user warning-device comprises:
a. at least one image sensor;
b. a memory unit; and
c. a processing unit for processing images,
wherein said image sensor is adapted to be worn by a user or to be carried by a selfie-drone associated with the user, such that images captured by said image sensor represent the surroundings of the user;
wherein said processing unit is configured to store said captured images in said memory unit;
wherein said processing unit is further configured to process said captured images to thereby detect one or more PHHs in the pathway of the user, during movement of the user, which health hazards may cause a stumble or the fall of the user;
wherein a safety/danger-score of a PHH is calculated, based on paraments including the type of PHH, size, unlevel, angle, un-stable, slipped surface, contrast, moving object, approaching speed, the time of day, the total number of occurrences, duration from appearing, re-occurrence, number of occurrence by the same user and number of occurrences by other users; and
wherein said processing unit is further configured to alert the user upon detecting at least one PHH.

9. The personal health hazards monitoring system of claim 8, wherein the safety score of a PHH is rated on a preconfigured hazard-scale that includes two or more of the following hazards:
a. fixed obstructions on pavements and user movement like a walking paths including curbs, cracks, fissures, uneven grates, manholes, pits, slopes, uneven paving, sidewalk gutters that are insufficiently marked or too narrow, light rail or streetcar tracks, drainage grates and outdoor stairs;
b. temporary obstructions on pavements and user movement like a walking paths—piles of uncollected trash, fruits/vegetable peeling, fallen leaves, pools of water after heavy rain and low hanging branches or other overhanging decorative items;
c. pavement construction materials including bricks surface such as cobble stone surface, tactile pavement for the visually impaired;
d. multiple sources of traffic/busy intersections;
e. vehicles, including cars, motorcycles, bicycles fully or partially parked on walkways, cyclists, skateboarders, other electric transporter and other devices used by pedestrians, predefined excessive pedestrian crowding and small children;
f. animal and other none-human subjects;
g. persons or animals carrying none-human subjects selected from a group including bacteria, fungal, virus and astrobiology mater;
h. weather conditions selected from the group of conditions including rain, snow and ice;
i. light conditions, including daylight, dim light, poor lighting, darkness;
j. recreational areas; and
k. input from a mobile device that distracts the user from paying attention to the pathway.

10. The personal health hazards monitoring system of claim 8, wherein said processing unit is configured to provide the user with instruction as to how to conduct his/her movements in order avoid encountering said detected PHH, and wherein said instruction include suggesting a stop of movement, slowing down of walk or a preferred walking deviation path to detour said detected PHH.

11. The personal health hazards monitoring system of claim 8, wherein a pedestrian user with a tactile-related device receives an automatic alert, wherein the alert is an automatic tactile sensing alert.

12. The personal health hazards monitoring system of claim 8, configured to interact with a health hazards geolocation control system for monitoring and maintaining potential health hazards endangering pedestrians using the system, wherein the health hazards geolocation control system comprises:
a. a remote pedestrians-server;
b. a user warning-device coupled with each pedestrian user;
c. a health hazards geographic map; and
d. a users-module configured to communicate with at least one user, wherein said health hazards geographic map comprises dynamically mapped potential health hazards (PHHs);
wherein each PHH is assigned a safety score;
wherein said remote pedestrians-server is configured to provide the user warning-device with a regional segment of said health hazards geographic map based on location received from said remote pedestrians-server; and
wherein said user warning-device is configured to alert the coupled pedestrian user upon approaching at least one PHH.

13. The personal health hazards monitoring system of claim 12, wherein said remote pedestrians-server is configured to manage, update, report PHHs and generate safe path plan using a Geographic Information System (GIS), upon receiving a request from a pedestrian user.

14. The personal health hazards monitoring system of claim 12, wherein upon the pedestrian being a persons that carries a none-human subject selected from a group including bacteria, fungal, virus and astrobiology mater, the pedestrian user reports his/her PHH state, being a mobile PHH, to said remote pedestrians-server, to thereby facilitate real-time and future avoidance of said mobile PHH by other pedestrian users.

15. A personal health hazards monitoring method for detecting health hazards, comprising the steps of:
a. providing a personal health hazards monitoring system as in claim 8;
b. processing images captured by said image sensor to detect an occurrence of at least one PHH;
c. calculating a safety/danger-score of a PHH based on paraments including the type of PHH, size, unlevel, angle, un-stable, slipped surface, contrast, moving object, approaching speed, the time of day, the total number of occurrences, duration from appearing, re-occurrence, number of occurrence by the same user and number of occurrences by other users; and
d. upon detecting said at least one potential health hazard, alerting the user of said detected PHH.

16. The health hazards monitoring method of claim 15, further comprising the step of:
a. providing the user with instruction as to how to conduct his movements in order avoid stumbling over said detected PHH.

17. The health hazards monitoring method of claim 15, wherein said potential pedestrian health hazards include:
a. fixed obstructions on pavements and user movement like a walking paths including curbs, cracks, fissures, uneven grates, manholes, pits, slopes, uneven paving, sidewalk gutters that are insufficiently marked or too narrow, light rail or streetcar tracks, drainage grates and outdoor stairs;
b. temporary obstructions on pavements and user movement like a walking paths—piles of uncollected trash, fruits/vegetable peeling, fallen leaves, pools of water after heavy rain and low hanging branches or other overhanging decorative items;
c. pavement construction materials including bricks surface such as cobble stone surface, tactile pavement for the visually impaired;
d. multiple sources of traffic/busy intersections;
e. vehicles, including cars, motorcycles, bicycles fully or partially parked on walkways, cyclists, skateboarders, other electric transporter and other devices used by pedestrian, predefined excessive pedestrian crowding and small children;
f. animals and other none-human subjects;
g. persons or animals carrying none-human subjects selected from a group including bacteria, fungal, virus and astrobiology mater;
h. weather conditions selected from the group of conditions including rain, snow and ice;
i. light conditions, including daylight, dim light, poor lighting, darkness;
j. recreational areas; and
k. input from a mobile device that distracts the user from paying attention to the pathway.

18. The health hazards monitoring method of claim 15, wherein upon detecting two or more potential health hazards, the method further comprises the step of discriminating between said detected potential health hazards, using a preconfigured danger-scale that predefines the danger level of potential health hazards.

19. The health hazards monitoring method of claim 15, wherein said alerting is performed automatically using a tactile-related device.

20. The health hazards monitoring method of claim 19, wherein said tactile alert is in the form of a vibration or other tactile sensing to the foot that mimics the feeling of an unbalanced safe step, that results with a quick stop of the user and maintaining the full body weight on the table foot.

21. The health hazards monitoring method of claim 15, wherein said alerting is transmitted to a remote center by wireless or by other communication means.

22. The health hazards monitoring method of claim 15, wherein said alerting is transmitted to a remote geolocation-server and/or data storage, by wireless or by other communication means.

23. The health hazards monitoring method of claim 15, wherein said detected PHH detection includes detecting a falling incident or a near-falling incident of the user.

24. The health hazards monitoring method of claim 23, wherein said detecting of a falling incident or a near-falling incident of the user uses image frames captured by said image sensor flown by said drone.

25. The health hazards monitoring method of claim 15, wherein said health hazards monitoring system is at least partially embodied on a personal mobile device.

26. The health hazards monitoring method of claim 15, wherein the user is a person, an animal or a none-human subject, on earth or on other planets.

27. The health hazards monitoring method of claim 15, wherein each of said persons carrying a contagious virus have been reported to either said health hazards monitoring system, or to a health hazards geolocation control system or both, by said person or by a third party.
